(19) United States
(12) Patent Application Publication
(10) Pub. No.: US 2017/0191429 A1
(43) Pub. Date: Jul. 6, 2017

(54) Use Of Intrusive Turbo Wastegate Control For Improved AFIM Detection Capability

(71) Applicant: GM Global Technology Operations LLC, Detroit, MI (US)

(72) Inventors: Vincent J. TYLUTKI, Livonia, MI (US); Kenneth L. MAROTTA, Macomb, MI (US); Linda GARCIA, Davisburg, MI (US); Sean SLADE, Detroit, MI (US); Ian J. MACEWEN, White Lake, MI (US)

(21) Appl. No.: 14/989,363

(22) Filed: Jan. 6, 2016

(51) Int. Cl. F02D 9/04; F02D 41/00; F02B 37/12

(52) U.S. Cl. CPC F02D 9/04; F02B 37/12; F02D 41/0007; F02D 2700/0212

(57) ABSTRACT

A system includes an air/fuel imbalance (AFIM) control module that determines a position of a wastegate, selectively opens the wastegate in response to a determination that the wastegate is not in a desired open position, and selectively generates an enable signal in response to a determination that the wastegate is in the desired open position. An AFIM calculation module receives an oxygen signal from an oxygen sensor positioned in fluid communication with exhaust flow from the wastegate and selectively calculates an AFIM in a cylinder bank of an engine based on the oxygen signal and the enable signal generated by the AFIM control module.

### FIELD

The present disclosure relates to internal combustion engines, and more particularly to systems and methods for detecting an air/fuel imbalance in internal combustion engines.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Engines combust a mixture of air and fuel to produce drive torque and propel a vehicle. More specifically, air is drawn into an engine through a throttle valve. Fuel provided by one or more fuel injectors mixes with the air to form the air/fuel mixture (e.g., an air/fuel ratio). The air/fuel mixture is combusted within one or more cylinders of the engine to produce torque. An engine control module (ECM) controls torque output by the engine.

Exhaust gas resulting from combustion of the air/fuel mixture is expelled from the engine to an exhaust system. One or more oxygen sensors measure oxygen in the exhaust gas and output signals accordingly. The ECM selectively adjusts the air and/or fuel of the air/fuel mixture based on the output of the oxygen sensors. For example, the ECM may adjust the air/fuel mixture to produce a stoichiometric air/fuel mixture (e.g., 14.7:1).

Adjustments of the air/fuel mixture also vary the components of the resulting exhaust gas. For example, combustion of a lean air/fuel mixture (e.g., greater than 14.7:1) produces exhaust gas that is hotter than exhaust gas produced when a stoichiometric air/fuel mixture is combusted. The exhaust gas resulting from combustion of the lean air/fuel mixture may also include a greater concentration of nitrogen oxides (NOx) than exhaust gas produced by combustion of the stoichiometric mixture. A rich air/fuel mixture (e.g., less than 14.7:1) may produce cooler exhaust gas having a greater concentration of carbon oxides than the exhaust gas produced by combustion of the stoichiometric mixture.

An air/fuel imbalance (AFIM) condition occurs when an air/fuel ratio of one or more cylinders of the engine is different than respective air/fuel ratios of other cylinders. The presence of an AFIM condition may cause difficulties in maintaining a desired (e.g., stoichiometric) air/fuel ratio.

### SUMMARY

A system includes an air/fuel imbalance (AFIM) control module that determines a position of a wastegate, selectively opens the wastegate in response to a determination that the wastegate is not in a desired open position, and selectively generates an enable signal in response to a determination that the wastegate is in the desired open position. An AFIM calculation module receives an oxygen signal from an oxygen sensor positioned in fluid communication with exhaust flow from the wastegate and selectively calculates an AFIM in a cylinder bank of an engine based on the oxygen signal and the enable signal generated by the AFIM control module.

A method includes determining a position of a wastegate, selectively opening the wastegate in response to a determination that the wastegate is not in a desired open position, selectively generating an enable signal in response to a determination that the wastegate is in the desired open position, receiving an oxygen signal from an oxygen sensor positioned in fluid communication with exhaust flow from the wastegate; and selectively calculating an AFIM in a cylinder bank of an engine based on the oxygen signal and the enable signal.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example engine system according to the principles of the present disclosure;

FIG. 2 is an example engine control module including an air/fuel imbalance detection module according to the principles of the present disclosure; and

FIG. 3 is an example air/fuel imbalance detection method according to the principles of the present disclosure.

In the drawings, reference numbers may be reused to identify similar and/or identical elements.

### DETAILED DESCRIPTION

An engine combusts an air/fuel mixture within cylinders of the engine. Combustion of the air/fuel mixture produces exhaust gas that is expelled from the cylinders. An air/fuel imbalance (AFIM) in a cylinder (and, accordingly, in a corresponding cylinder bank) may interfere with maintaining a stoichiometric air/fuel mixture in the engine.

Accurately detecting and diagnosing an AFIM in the engine is therefore desirable for performing one or more adjustments to correct the AFIM. AFIM systems and methods according to the principles of the present disclosure provide improved accuracy for AFIM detection by aligning an oxygen sensor with exhaust flow output from a wastegate of a turbocharger and selectively controlling the wastegate during AFIM detection.

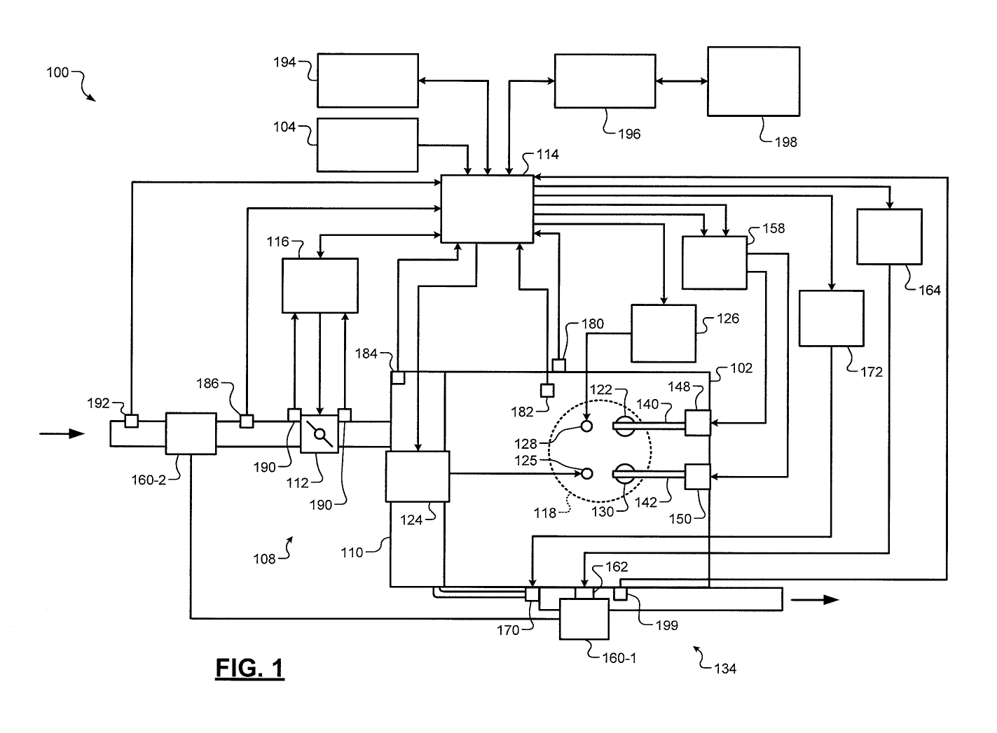

Referring now to FIG. 1, an engine system 100 includes an engine 102 that combusts an air/fuel mixture to produce drive torque for a vehicle. The amount of drive torque produced by the engine 102 is based on a driver input from a driver input module 104. The driver input may be based on a position of an accelerator pedal. The driver input may also be based on a cruise control system, which may be an adaptive cruise control system that varies vehicle speed to maintain a predetermined following distance.

Air is drawn into the engine 102 through an intake system 108. The intake system 108 includes an intake manifold 110 and a throttle valve 112. The throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injections performed by a fuel injector 125 to achieve a desired air/fuel ratio. Fuel may be injected into the intake manifold 110 at a central location or at multiple locations, such as near the intake valve 122 of each of the cylinders. In various implementations, fuel may be injected directly into the cylinders or into mixing chambers associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 to generate a spark in the cylinder 118 based on a signal from the ECM 114, which ignites the air/fuel mixture. The timing of the spark may be specified relative to the time when the piston is at its topmost position, referred to as top dead center (TDC).

The spark actuator module 126 may be controlled by a spark timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, combustion of the air/fuel mixture drives the piston down, thereby driving the crankshaft. The combustion stroke may be defined as the time between the piston reaching TDC and the time at which the piston returns to bottom dead center (BDC). During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. A valve actuator module 158 may control the intake and exhaust cam phasers 148 and 150 based on signals from the ECM 114. When implemented, variable valve lift may also be controlled by the valve actuator module 158.

The ECM 114 may deactivate the cylinder 118 by instructing the valve actuator module 158 to disable opening of the intake valve 122 and/or the exhaust valve 130. The valve actuator module 158 may disable opening of the intake valve 122 by decoupling the intake valve 122 from the intake camshaft 140. Similarly, the valve actuator module 158 may disable opening of the exhaust valve 130 by decoupling the exhaust valve 130 from the exhaust camshaft 142. In various implementations, the valve actuator module 158 may actuate the intake valve 122 and/or the exhaust valve 130 using devices other than camshafts, such as electromagnetic or electrohydraulic actuators.

The engine system 100 may include a boost device that provides pressurized air to the intake manifold 110. For example, FIG. 1 shows a turbocharger including a hot turbine 160-1 that is powered by hot exhaust gases flowing through the exhaust system 134. The turbocharger also includes a cold air compressor 160-2, driven by the turbine 160-1, which compresses air leading into the throttle valve 112. In various implementations, a supercharger (not shown), driven by the crankshaft, may compress air from the throttle valve 112 and deliver the compressed air to the intake manifold 110.

A wastegate 162 may allow exhaust to bypass the turbine 160-1, thereby reducing the boost (the amount of intake air compression) of the turbocharger. The ECM 114 may control the turbocharger via a boost actuator module 164. The boost actuator module 164 may modulate the boost of the turbocharger by controlling the position of the wastegate 162. In various implementations, multiple turbochargers may be controlled by the boost actuator module 164. The turbocharger may have variable geometry, which may be controlled by the boost actuator module 164.

An intercooler (not shown) may dissipate some of the heat contained in the compressed air charge, which is generated as the air is compressed. The compressed air charge may also have absorbed heat from components of the exhaust system 134. Although shown separated for purposes of illustration, the turbine 160-1 and the compressor 160-2 may be attached to each other, placing intake air in close proximity to hot exhaust.

The exhaust system 134 may include an exhaust gas recirculation (EGR) valve 170, which selectively redirects exhaust gas back to the intake manifold 110. The EGR valve 170 may be located upstream of the turbocharger's turbine 160-1. The EGR valve 170 may be controlled by an EGR actuator module 172.

The engine system 100 may measure the position of the crankshaft using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The ECM 114 uses signals from the sensors to make control decisions for the engine system 100.

The ECM 114 may communicate with a transmission control module (TCM) 194 to coordinate shifting gears in a transmission (not shown). For example, the ECM 114 may reduce engine torque during a gear shift. The ECM 114 may communicate with a hybrid control module (HCM) 196 to coordinate operation of the engine 102 and an electric motor 198. The electric motor 198 may also function as a generator, and may be used to produce electrical energy for use by the vehicle's electrical systems and/or for storage in a battery. In various implementations, various functions of the ECM 114, the TCM 194, and the HCM 196 may be integrated into one or more modules.

The ECM 114 selectively diagnoses an AFIM in a first cylinder bank (e.g., a cylinder bank including the representative cylinder 118). The ECM 114 diagnoses (e.g., detects) an AFIM in a cylinder bank based on oxygen in exhaust gas expelled from cylinders of that cylinder bank. For example only, the ECM 114 may selectively diagnose an AFIM in the first cylinder bank including the cylinder 118 based on an oxygen signal output by an oxygen sensor 199. The ECM 114 may compare data corresponding to the oxygen signal output by the oxygen sensor 199 to data corresponding to oxygen signals output by one or more other oxygen sensors (not shown) associated with a second cylinder bank to diagnose an AFIM in one of the cylinder banks.

The ECM 114 according to the principles of the present disclosure selectively opens the wastegate 162 to allow exhaust to bypass the turbine 160-1 during AFIM detection. The wastegate 162 directs the exhaust gas flow toward the oxygen sensor 199 arranged at an outlet of the wastegate 162. For example, the oxygen sensor 199 may be directly aligned with the flow of exhaust output from the wastegate 162 (e.g., the oxygen sensor 199 may centered with respect to a center axis of the opening of the wastegate 162). The position (e.g., fully closed, partially open or closed, fully open, etc.) of the wastegate 162 may be controlled to modulate the amount of exhaust directed at the oxygen sensor 199 during various portions of the AFIM detection. In this manner, AFIM detection may be improved.

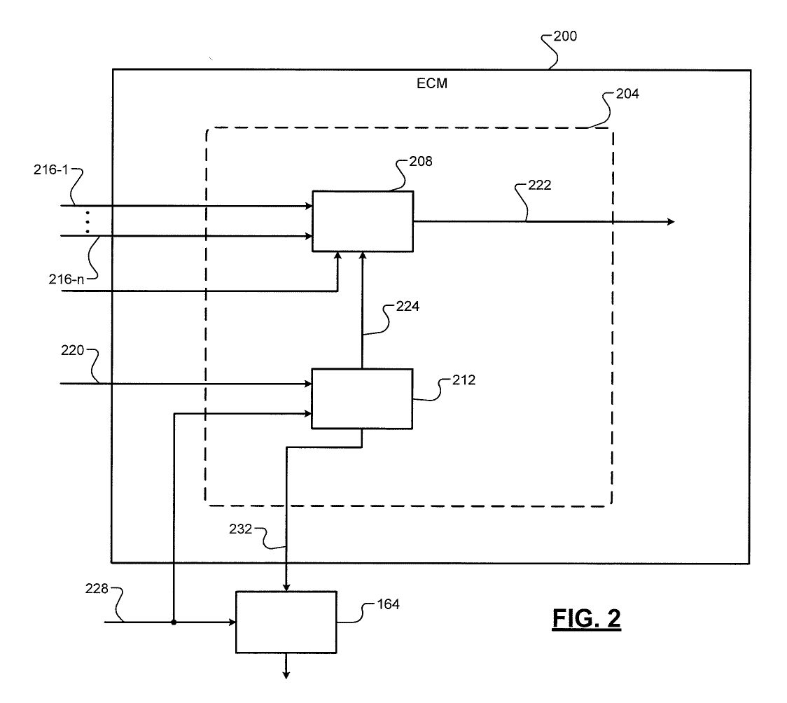

Referring now to FIG. 2, an example ECM 200 may include an AFIM detection module 204 that selectively detects and diagnoses an AFIM. While the AFIM detection module 204 is discussed as being located within the ECM 200, the AFIM detection module 204 may be located in any suitable location, such as externally to the ECM 200 and/or within any other suitable module or system.

The AFIM detection module 204 includes an AFIM calculation module 208 and an AFIM control module 212. The AFIM calculation module 208 receives oxygen signals 216-1 . . . 216-n (referred to collectively as oxygen signals 216) corresponding to respective cylinder banks, and may receive one or more other signals 220 indicative of various engine operating parameters. For example, the signal 220 may correspond to one or more of engine speed, engine load, vehicle speed, selected gear, crankshaft angle, etc. The AFIM calculation module 208 samples the oxygen signals 216 (e.g., in accordance with various parameters indicated by the signal 220) and calculates an AFIM based on the oxygen signals 216. For example only, timing of the samples may correspond to firing events of cylinders in respective cylinder banks as indicated by a crankshaft angle, timestamps assigned to the samples, etc. In this manner, the AFIM calculation module 208 collects AFIM data corresponding to the respective cylinder banks and may be configured to associate each sample with a respective cylinder and/or cylinder bank.

The AFIM calculation module 208 uses the AFIM data to perform AFIM detection using any suitable method and outputs an AFIM indication signal 222 accordingly. The ECM 200 may perform one or more functions in response to the AFIM indication signal 222. For example, the ECM 200 may activate a check engine light or other diagnostic indicator, and/or may adjust performance parameters (e.g., adjust fuel timing, ignition timing, air/fuel ratios, etc.) in response to the AFIM indication signal 222. In some examples, the AFIM indication signal 222 may only indicate the detection of an AFIM. In other example, the AFIM indication signal 222 may indicate which cylinder bank has an AFIM condition. In still another example, the AFIM indication signal 222 may indicate which cylinder has the AFIM condition.

The AFIM control module 212 may selectively enable AFIM detection performed by the AFIM calculation module 212 and/or selectively actuate the boost actuator module 164 in accordance with AFIM detection. For example, the AFIM calculation module 208 may continuously receive, sample, and/or store data indicative of the oxygen signals 216, or may only store the data when AFIM detection is enabled by AFIM control module 212. For example only, the AFIM control module 212 may enable AFIM detection (e.g., via enable signal 224 in response to one or more vehicle operating conditions being met (e.g., as indicated by signal 220). In some examples, AFIM detection may be enabled when the vehicle is in a steady state condition, when engine load is within a predetermined range, when engine speed and/or vehicle speed are within a predetermined range, etc.

The AFIM control module 212 further enables AFIM detection based on a position of the wastegate 162, and/or actively controls the position of the wastegate 162 during AFIM detection. In some examples, the AFIM control module 212 receives an indication (e.g., via signal 228) of the position of the wastegate 162. For example, the signal 228 may correspond to a control signal provided to the boost actuator module 164 for selectively controlling the position of the wastegate 162. Accordingly, the AFIM control module 212 determines a position of the wastegate 162 based on the signal 228 and selectively enables AFIM detection based on the position of the wastegate 162. For example, the AFIM control module 212 may enable AFIM detection via the signal 224 when the signal 228 indicates that the wastegate 162 is fully open, above a percent open threshold, etc.

In other examples, the AFIM control module 212 actively controls the position of the wastegate 162 using a wastegate control signal 232. For example, the AFIM control module 212 may control the boost actuator module 164 to open the wastegate 162 to a desired position (e.g., to a minimum percent open position, to a fully open position, etc.) and concurrently (or within a predetermined period) enable AFIM detection. In this manner, the AFIM control module 212 ensures that sufficient exhaust flow is directed at the oxygen sensor 199 during AFIM detection to maximize the accuracy of the oxygen signals 216.

In an example embodiment, the AFIM control module 212 ensures that the AFIM calculation module 208 performs AFIM detection at least once per a predetermined period. For example, the AFIM control module 212 may increment a timer indicating an amount of time (i.e., an elapsed period) since a previous AFIM detection. If AFIM detection is performed, the AFIM control module 212 may reset the timer. Conversely, if the timer reaches a threshold corresponding to the predetermined period without AFIM detection being performed, the AFIM control module 212 may force the wastegate 162 to the desired open position and enable AFIM detection.

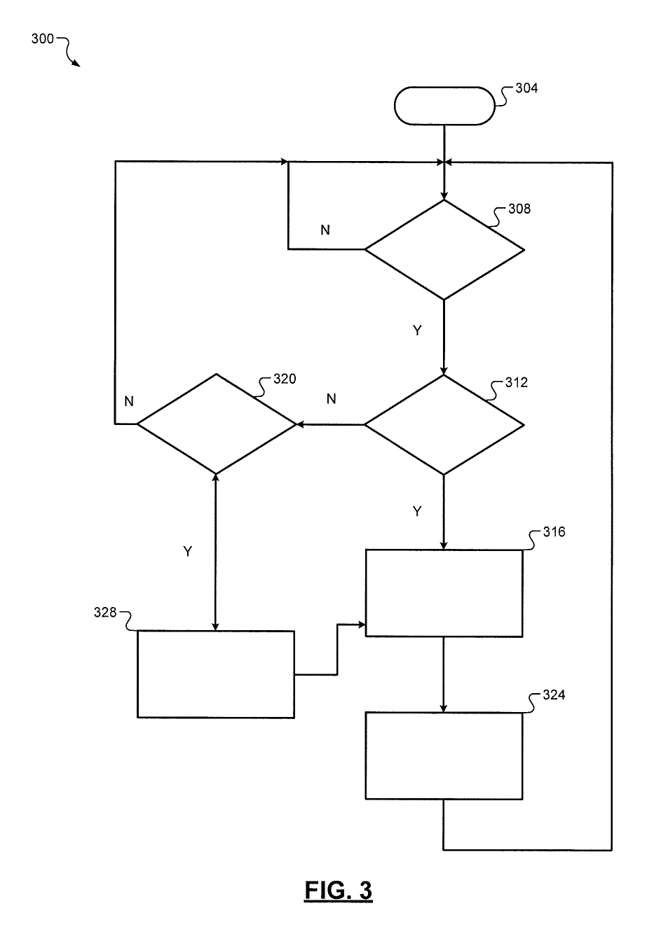

Referring now to FIG. 3, an example AFIM detection method 300 according to the principles of the present disclosure begins at 304. At 308, the method 300 determines whether AFIM detection is enabled. For example, the AFIM control module 212 determines whether one or more vehicle conditions associated with AFIM detection are met. If true, the method 300 continues to 312. If false, the method 300 continues to 308.

At 312, the method 300 determines whether the wastegate 162 is in a desired open position (e.g., fully open, at or greater than a minimum percent open position, etc.). For example, the AFIM control module 212 determines the position of the wastegate 162. If true, the method 300 continues to 316. If false, the method 300 continues to 320. At 316, the method 300 (e.g., the AFIM calculation module 208) performs AFIM detection and generates an AFIM indication signal accordingly. At 324, the method 300 (e.g., the AFIM control module 212) resets a timer and continues to 308.

At 320, the method 300 determines whether an amount of time since a previous AFIM detection was performed is greater than or equal to a predetermined period. For example, the AFIM control module 212 compares a value of the timer to the predetermined period. If true, the method 300 continues to 328. If false, the method 300 continues to 308. At 328, the control module 212 commands the wastegate 162 to the desired open position and the method 300 continues to 316 to perform AFIM detection.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A system, comprising:
an air/fuel imbalance (AFIM) control module that determines a position of a wastegate, that selectively opens the wastegate in response to a determination that the wastegate is not in a desired open position, and that selectively generates an enable signal in response to a determination that the wastegate is in the desired open position; and
an AFIM calculation module that receives an oxygen signal from an oxygen sensor positioned in fluid communication with exhaust flow from the wastegate and that selectively calculates an AFIM in a cylinder bank of an engine based on the oxygen signal and the enable signal generated by the AFIM control module.

2. The system of claim 1, wherein the desired open position corresponds to one of a fully open position and a minimum percent open position.

3. The system of claim 1, wherein, in response to a determination that the wastegate is not in the desired open position, the AFIM control module determines a period elapsed since the AFIM calculation module previously calculated the AFIM.

4. The system of claim 3, wherein the AFIM control module selectively opens the wastegate and generates the enable signal based on the determined elapsed period.

5. The system of claim 4, wherein, in response to generating the enable signal, the AFIM control module resets a timer that indicates the period elapsed since the AFIM calculation module previously calculated the AFIM.

6. The system of claim 4, wherein the AFIM control module (i) compares the determined elapsed period to a predetermined period and (ii) opens the wastegate to the desired open position and generates the enable signal when the determined elapsed period is greater than or equal to the predetermined period.

7. The system of claim 1, wherein the AFIM control module generates the enable signal in response to a determination that the wastegate is in the desired open position and further based on a determination that one or more vehicle operating conditions are met.

8. The system of claim 1, wherein the AFIM calculation module generates an AFIM indication signal based on the calculation of the AFIM.

9. The system of claim 8, wherein the AFIM indication signal indicates at least one of an indication of the AFIM, an indication of the cylinder bank having the AFIM, and an indication of a cylinder having the AFIM.

10. A method, comprising:
determining a position of a wastegate;
selectively opening the wastegate in response to a determination that the wastegate is not in a desired open position;
selectively generating an enable signal in response to a determination that the wastegate is in the desired open position;
receiving an oxygen signal from an oxygen sensor positioned in fluid communication with exhaust flow from the wastegate; and
selectively calculating an AFIM in a cylinder bank of an engine based on the oxygen signal and the enable signal.

11. The method of claim 10, wherein the desired open position corresponds to one of a fully open position and a minimum percent open position.

12. The method of claim 10, further comprising, in response to a determination that the wastegate is not in the desired open position, determining a period elapsed since the AFIM was previously calculated.

13. The method of claim 12, further comprising selectively opening the wastegate and generating the enable signal based on the determined elapsed period.

14. The method of claim 13, further comprising, in response to generating the enable signal, resetting a timer that indicates the period elapsed since the AFIM was previously calculated.

15. The method of claim 13, further comprising (i) comparing the determined elapsed period to a predetermined period and (ii) opening the wastegate to the desired open position and generating the enable signal when the determined elapsed period is greater than or equal to the predetermined period.

16. The method of claim 10, further comprising generating the enable signal in response to a determination that the wastegate is in the desired open position and further based on a determination that one or more vehicle operating conditions are met.

17. The method of claim 10, further comprising generating an AFIM indication signal based on the calculation of the AFIM.

18. The method of claim 17, wherein the AFIM indication signal indicates at least one of an indication of the AFIM, an indication of the cylinder bank having the AFIM, and an indication of a cylinder having the AFIM.
